(19) United States
(12) Patent Application Publication
(10) Pub. No.: US 2012/0088071 A1
(43) Pub. Date: Apr. 12, 2012

(54) ROOFING MATERIAL WITH DIRECTIONALLY DEPENDENT PROPERTIES AND METHOD OF MAKING THE SAME

(75) Inventors: Kirk M. Bailey, Brigham City, UT (US); Jeffrey T. Holman, Farmington, UT (US)

(73) Assignee: COOL ANGLE LLC, Farmington, UT (US)

(21) Appl. No.: 13/220,028

(22) Filed: Aug. 29, 2011

Related U.S. Application Data
(63) Continuation-in-part of application No. 12/898,713, filed on Oct. 6, 2010, now Pat. No. 8,007,898.
(60) Provisional application No. 61/469,226, filed on Mar. 30, 2011.

(51) Int. Cl. D06N 7/04; B05D 1/36; B05D 5/00; B41M 5/00

(52) U.S. Cl. 428/143; 428/195.1; 427/267; 427/258; 427/270

(57) ABSTRACT

A roofing material has multiple coatings with at least one directionally disposed coating. The roofing material has at least one non-planar surface for exposure to environmental conditions. A first coating is directionally disposed on a portion of the non-planar surface to cover less than all of the non-planar surface. The first coating has a visual attribute and an energy-efficiency attribute which are both different from corresponding visual and energy-efficiency attributes of the non-planar surface on which the first coating is disposed. A second coating is directionally disposed on at least a portion of the first coating. The second coating has a visual attribute which is different from the visual attributes of both the first coating and the non-planar surface.

### CROSS-REFERENCE TO RELATED APPLICATIONS

This application deals with subject matter that is related to the U.S. patent application Ser. No. 12/898,713, which was filed on Oct. 6, 2010, and is incorporated by reference herein. Additionally, this application deals with subject matter that is related to the U.S. Provisional Patent Application No. 61/469,226, which was filed on Mar. 30, 2011, and is incorporated by reference herein.

### BACKGROUND

Several types of roofing material are commercially available including asphalt shingles, wood shingles, metal roofing, slate, clay tiles, built-up roofs, roll roofing, polyurethane foam, single-ply roof membranes, and others. Asphalt shingles are by far the most commonly used in the U.S. for residential sloped-roof applications. Asphalt shingles are constructed of a felt or fiberglass mat that is saturated with asphalt and covered with granules which are adhered to the mat. Advantages of this type of roofing include its low cost, durability, aesthetic variety (colors, shading, layers, and textures), as well as ease of installation and repair. The granules of asphalt shingles are generally derived from a hard mineral base rock such as slate, basalt, or nephelite, and are typically ground to a particle size of about 10 to 35 US mesh. Granules are typically coated prior to being applied to shingles to achieve a variety of desired properties. This has been done for many years as illustrated by U.S. Pat. No. 2,379,358 (1945) to Jewett.

The aesthetic properties of roofing systems play a primary role in marketing. As a result, asphalt shingles are often tailored to achieve certain appearances. This tailoring is typically accomplished through uniform granule coating and by applying a mixture of granules in various color schemes and patterns and/or layering shingles to simulate more traditional, and in most cases more expensive, forms of roof coverings such as wooden shake, slate, or tile. Examples of these methods are described in U.S. Pat. No. 7,665,261 (2010) to Elliott et al., U.S. Pat. No. 6,289,648 (2001) to Freshwater et al., and U.S. Pat. No. 6,014,847 (2000) to Phillips with the layering approach emphasized in U.S. Patent Application Publications 2010/0205898 and 2010/0192501 and U.S. Pat. No. 6,698,151 (2004) to Elliott. U.S. Pat. No. 6,715,252 (2004) and U.S. Pat. No. 6,523,316 (2003), both to Stahl et al., describe the combination of coloring and layering with colors changing at edges facing specific directions to achieve a sharp, precise delineation between zones of different shadings in an interesting effort to simulate the depth of more expensive shingles. U.S. Pat. No. 7,638,164 (2009) to Aschenbeck and U.S. Pat. No. 4,583,486 (1986) to Miller describe methods for accurate granule placement in complex patterns to achieve desired aesthetics. Darker and multi-toned shingles remain preferred in the market place. The visual appearance of a material is strongly influenced by the surface properties, including color, tone, reflectivity, and surface irregularities and their orientation. The resulting properties of all tailoring for visual effect are referred to herein as “tailored aesthetic properties.”

The effective directional dependence of appearance is strongly influenced by surface properties and orientation. Methods described in the prior art to improve the visual appearance do so with large-scale efforts apparently without considering that these properties can be tailored to have directional preference at the granule level.

While the aesthetics of a roofing system remain of primary marketing importance, effective service life has always been important and energy considerations are becoming increasingly important in the selection of roofing materials. In particular, roofs that reflect large amounts of solar radiation are becoming favored because they reduce the temperature of the shingles thereby extending the service life of the shingles and reducing the cooling loads for the building. In addition, as described in U.S. Pat. No. 7,648,755 (2010) to Gross et al., hotter roofs in metropolitan areas can result in a “heat island effect” causing ambient air temperatures to be as much as 10° F. higher than in surrounding rural areas.

As described in U.S. Pat. No. 7,592,066 (2009) to Shiao et al., conventional asphalt shingles are known to have low heat reflectance in the spectral band associated with solar radiation. This spectral band is predominantly in the near infrared range (700 nm to 2500 nm). As a result, conventional asphalt shingles absorb a large portion of incident solar radiation. This low solar reflectance can be exacerbated with dark coloring of the granules. The patent of Shiao et al. indicates that dark colored asphalt shingles have solar reflectances of only 0.05 to 0.15. The heat absorbing properties of conventional shingles result in elevated roof temperatures that adversely affect shingle service life and cooling requirements. Special treatments can be incorporated to increase the reflectivity of asphalt shingles. These treatments can be applied specifically to the granules or to the entire shingle. The thermal response of a material to incident radiation such as solar radiation is determined by the surface radiation properties. These include the reflectivity, absorptivity, transmissivity, and emissivity. Methods described in the prior art to improve the thermal response to solar incidence do so by incorporating features that effect the surface radiation properties. In particular, treatments that increase the surface reflectivity are commonly used. The resulting properties of any such tailoring, including the use of reflective granules, coatings, paints, powders, or other means designed to alter the radiation properties in order to improve thermal performance is referred to herein as “tailored radiation properties.”

The effective directional dependence of reflectivity is strongly influenced by surface properties and orientation. Methods described in the prior art to improve the radiation properties do so with large-scale efforts apparently without considering that these properties can be tailored to have directional preference at the granule level.

Effective methods for obtaining highly reflective granules have been pursued for many years as illustrated by U.S. Pat. No. 2,732,311 (1956) to Hartwright. Modern efforts have focused on balancing the desire for high reflectivity with that for darker tones. This results in compromising both areas of interest. Many schemes have been developed to accomplish this balance as demonstrated in U.S. Patent Application Publications 2010/0203336, 2010/0151199, 2010/0104857, 2008/0241472, and 2008/0008832 as well as patents U.S. Pat. No. 7,648,755 (2010) to Gross et al. and U.S. Pat. No. 7,241,500 (2007) to Shiao et al. These include solar reflective particles dispersed in a binder at a desired depth, coated reflective granules, reflective coatings, multiple coatings, colored particles within a coating, and reflective particles within a colored coating. Regardless of these efforts the most reflective roofs are light in color.

Instead of treating granules to increase their reflectivity, the granules can be replaced with a more reflective material such as the metal flakes described in U.S. Patent Application Publication 2009/0117329. This method can result in improved reflectivity, but requires deviation from the established, efficient, and low-cost process of producing rock-based granule-coated shingles. In addition, this method does not take advantage of the extensive availability of aesthetic choices for typical granule-based shingles.

Methods have been developed to increase average resulting shingle reflectivity by applying a layer of reflective material to the surface of the shingle. This reflective layer can be in the form of a paint as in U.S. Patent Application Publication 2009/0317593, U.S. Pat. No. 7,291,358 (2007) to Fensel et al., and U.S. Patent Application Publication 2007/0110961 or a powder as in U.S. Pat. No. 7,452,598 (2008) to Shiao et al. and U.S. Pat. No. 7,422,989 (2008) to Kalkanolu et al. This is most effective with the use of highly reflective materials that are generally light in color and these methods produce roofs that are light colored in appearance regardless of the direction from which they are viewed.

U.S. Pat. No. 7,291,358 (2007) and U.S. Pat. No. 6,933,007 (2005), both to Fensel et al., and U.S. Patent Application Publications 2005/0238848, 2007/0110961, and 2009/0317593 describe the use of two sizes of granules to increase granule coverage. The smaller granules are sized to fit in the interstices between the larger granules thereby reducing the amount of non-reflective asphalt material exposed to solar radiation. This can increase the average resulting shingle reflectance since the granules are typically more reflective than the black asphalt substrate. This is most effective with the use of highly reflective granules that are generally light in color. These methods produce roofs that are light colored in appearance regardless of the direction from which they are viewed.

Popular shingle materials have a variety of shapes. Wood shake shingles are very thin at the uppermost end tapering to considerably thicker at the lower, exposed end. Tile shingles have a variety of curved or flat shapes with interlocking features at interfaces designed to prevent water penetration of the shingle system. While there are a variety of shapes of popular shingles, none of the current art designs capitalize on shape to accomplish directional properties. More particularly, there have been no attempts to create shingles with large scale surfaces that face the sun direction and others that face the viewing direction to facilitate directional tailoring for desired properties.

### SUMMARY

Embodiments of a roofing material are described. In one embodiment, the roofing material includes a roofing material with at least one non-planar surface for exposure to environmental conditions. A first coating is directionally disposed on a portion of the non-planar surface to cover less than all of the non-planar surface. The first coating has a visual attribute and an energy-efficiency attribute which are both different from corresponding visual and energy-efficiency attributes of the non-planar surface on which the first coating is disposed. A second coating is directionally disposed on at least a portion of the first coating. The second coating has a visual attribute which is different from the visual attributes of both the first coating and the non-planar surface. Other embodiments of the roofing material are also described.

Embodiments of a method are also described. In one embodiment, the method is a method for manufacturing a roofing material. The method includes positioning a roofing material relative to a coating nozzle for first and second coatings. The method also includes directionally applying the first coating on a portion of the non-planar surface to cover less than all of the non-planar surface. The first coating has a visual attribute and an energy-efficiency attribute which are both different from corresponding visual and energy-efficiency attributes of the non-planar surface on which the first coating is disposed. The method also includes directionally applying the second coating on at least a portion of the first coating. The second coating has a visual attribute which is different from the visual attributes of both the first coating and the non-planar surface. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of the “sun-direction” and the “view-direction” for a typical roof.

FIG. 2 depicts a schematic diagram of one embodiment of a cross-section of an asphalt shingle with the dark granules and substrate coated with a material of high reflectivity in the sun-direction.

FIG. 3 depicts a schematic diagram of one embodiment of a section of a black asphalt shingle with three types of surface conditions viewed from the sun-direction.

FIG. 4 depicts a schematic diagram of one embodiment of a section of a black asphalt shingle with three types of surface conditions viewed from the view-direction.

FIG. 5 depicts a schematic diagram of one embodiment of a cross-section of an asphalt shingle with reflective granules and substrate coated with a dark material in the view-direction.

FIG. 6 depicts a schematic diagram of one embodiment of a cross-section of an asphalt shingle with generic granules and substrate coated with a material of high reflectivity in the sun-direction and a dark material in the view-direction.

FIG. 7 depicts a schematic diagram of one embodiment of a cross-section of an asphalt shingle with granules of bimodal size distribution with large dark granules and small reflective granules.

FIG. 8 depicts a schematic diagram of one embodiment of a cross-section of an asphalt shingle with granules of bimodal size distribution.

FIG. 9 depicts a schematic diagram of one embodiment of a stepped shingle tailored to have high reflectivity in the sun-direction and pleasing aesthetics in the view-direction.

FIG. 10A depicts a schematic diagram of one embodiment of a controlled pattern of separate coatings.

FIG. 10B depicts a schematic diagram of another embodiment of a controlled pattern of separate coatings.

FIG. 11A depicts a cross-sectional view of one embodiment of various incident angles from which different coatings may be applied to a roofing material.

FIG. 11B depicts a plan view of another embodiment of various incident angles from which different coatings may be applied to a roofing material.

FIG. 12 depicts a schematic diagram of a system for treating a roofing material to have a coating of material of high reflectivity in the sun-direction and a dark material in the view-direction.

FIG. 13A depicts a cross-sectional view of one embodiment of a roofing material with directionally toned triangular granules applied to a base material.

FIG. 13B depicts a graph of a reflectivity response of the roofing material of FIG. 13A.

FIG. 14A depicts a cross-sectional view of another embodiment of a roofing material with directionally toned triangular granules with asymmetrical shapes.

FIG. 14B depicts a graph of a reflectivity response of the roofing material of FIG. 14A.

FIG. 15A depicts a cross-sectional view of another embodiment of a roofing material with directionally toned triangular granules with asymmetrical shapes.

FIG. 15B depicts a graph of a reflectivity response of the roofing material of FIG. 15A.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

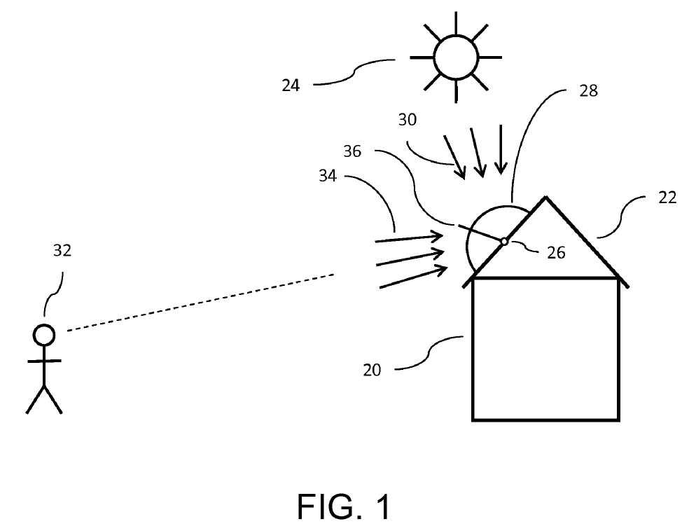

FIG. 1 illustrates the two directions for an application on a sloped roof. A typical building 20 has a roof 22 that is subjected to incident radiation loads from the sun 24. This incident radiation is in the form of both direct and diffuse radiation; direct passing directly through the atmosphere thereby maintaining its direction, diffuse having been scattered by the atmosphere thereby losing its directional orientation. While the direction of incident radiation is not fixed, it is predominantly coming from directions above the roof, and in particular those directed toward the sun and sky. For any point on the roof 26, local incidence is then predominantly associated with vectors passing through the upper portion of a hemisphere 28 centered on the point. These directions are transient due to the changing position of the sun, but they are predominantly upward. This collection of upward directions is denoted here as the “sun-direction” 30. Whereas the sun direction is predominantly from the upward (or sky) directions, a viewer 32 predominantly observes the roof from the downward (or ground) directions. These directions are variable due to, for example, elevation changes in the local terrain, but they are predominantly from the downward directions. The collection of vectors passing from these prominent viewing directions through the lower portion of the hemisphere to a point on the surface makes up the “view-direction” 34.

The thermal response of a material to incident radiation such as solar radiation is determined by the surface radiation properties. These include the reflectivity, absorptivity, transmissivity and emissivity. The effective directional dependence is strongly influenced by surface properties and orientation. The same properties also influence the visual appearance of a material; that is, surface irregularities and surface radiation properties. All of the methods described in the prior art to improve the thermal response to solar incidence do so by incorporating features that effect the surface radiation properties. In particular, treatments that increase the surface reflectivity are commonly used. The resulting properties of any such tailoring, including the use of reflective granules, coatings, paints, powders or other means designed to alter the radiation properties in order to improve thermal performance is referred to here as “tailored radiation properties.” The results of any tailoring to achieve desired aesthetics are referred to here as “tailored aesthetics.” This includes tailoring such as that described in the prior art including the use of colors, texturing, shading, layering or any other means of achieving desired visual effects.

With respect to the roofing system of FIG. 1, the predominant payoff of tailored radiation properties is associated with surface properties in the sun-direction since the largest fraction of solar incidence is associated with that direction. On the other hand, the predominant payoff of tailored aesthetics is associated with properties in the view-direction since the surface is predominantly viewed in that direction. What is lacking in the prior art is directionally dependent tailored radiation properties and tailored aesthetics, and in particular tailored radiation properties in the sun-direction and tailored aesthetics in the view-direction. That deficiency is addressed in the following embodiments which provide tailored radiation properties in the sun-direction and tailored aesthetics in the view-direction.

A line depicting demarcation 36 between the two collections of directions making up the sun-direction 30 and the view-direction 34 is shown in FIG. 1. However, there need not be a distinct demarcation between the two directions. Any fraction of all possible directions may be tailored for reflectivity from the sun-direction and aesthetics from the view-direction so long as tailoring of both has been achieved.

Various embodiments provide roofing materials with tailored radiation properties in the sun-direction and tailored aesthetics in the view-direction. High reflectivity of solar radiation in the sun-direction is desirable to extend the service life of the shingles and to reduce heating loads for the building. Visual properties with favorable aesthetics are desired in the view-direction to enhance the attractiveness of the roof. These tailored properties are accomplished by providing directional treatments on irregular surfaces of the roofing materials. The irregular surfaces can be inherently provided by materials common to the current art such as granule-coated asphalt shingles. Asphalt shingles have granules that vary in size, shape and orientation resulting in an irregular surface. The irregular surfaces can also be accomplished through the creation of surface shapes specifically designed to provide orientations in the sun-direction and view-direction.

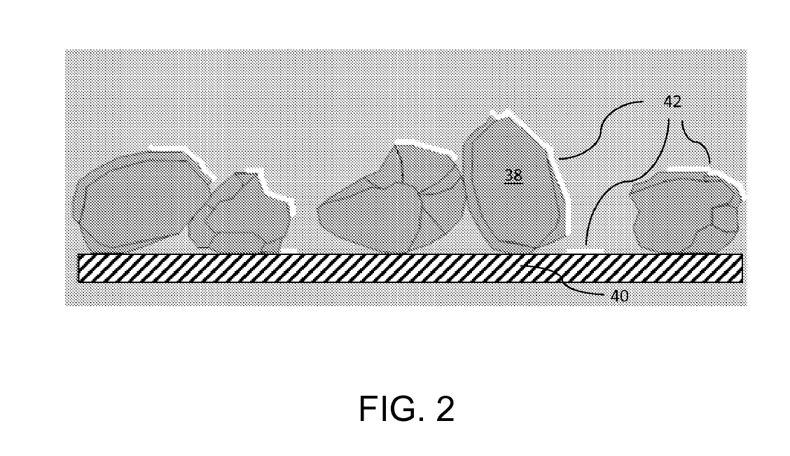

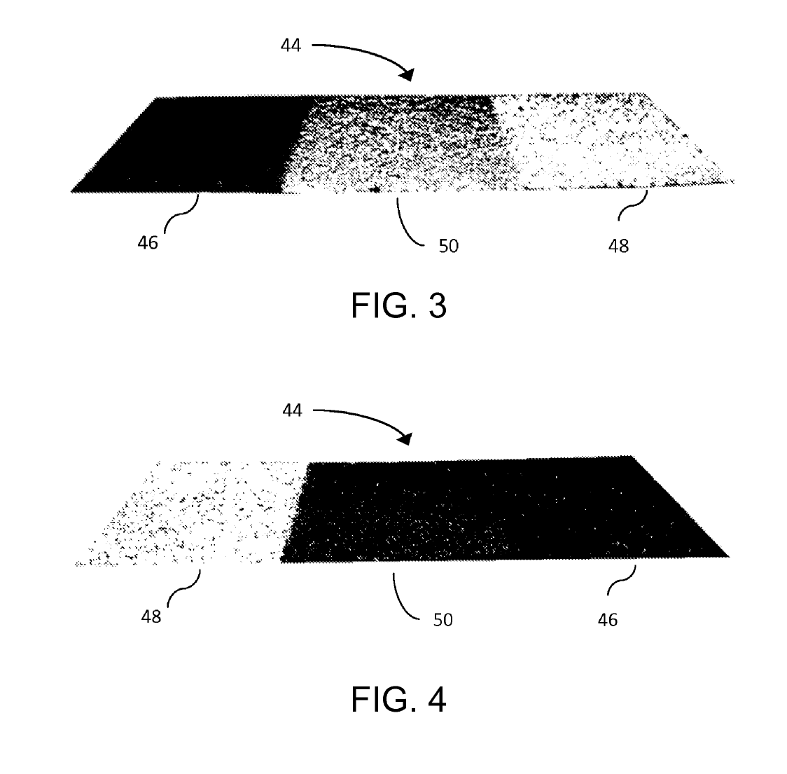

FIG. 2 depicts the first embodiment wherein shingle granules with tailored aesthetics 38 are adhered to an asphalt-impregnated substrate such as felt or fiberglass 40. The granules are then directionally coated with material with tailored radiation properties in the form of high reflectivity 42 on the surfaces of the shingles facing the sun-direction. This can easily be accomplished by applying the coating at a consistent predetermined angle with the proper application equipment and settings. The aesthetics of the view-direction are maintained by excluding that direction from high reflectivity treatment. The visual effect of this type of treatment is shown in FIG. 3 which provides a photograph of a section of a black asphalt shingle 44 with three different surface conditions; one that remains black 46, one uniformly coated with high reflectivity white coating 48, and one treated with directionally applied high reflectivity white coating 50. In this figure the shingles are photographed from within the sun-direction. From this view, the white 48 and the directionally treated 50 surfaces look similar indicating that the two will have similar reflective properties on surfaces facing the sun-direction. FIG. 4 shows a photograph of the same shingle 44 section taken from within the view-direction. Here, the directionally treated surface 50 appears similar to the untreated black surface 46, illustrating that the two have similar aesthetics from the view-direction.

Testing was done using the asphalt shingle samples shown in FIGS. 3 and 4 to compare the temperature response to solar heat flux of black shingle material (black), black shingle material uniformly coated with white coating (white) and black shingle material with a directionally applied white coating (black/white). The shingle samples were attached to an insulating layer of cardboard. Three 20-mil diameter type K thermocouples were positioned between the single material and the cardboard, centered within each sample. The testing was done by placing the test article in direct sunlight in a typical sloped-roof orientation at approximately 3:00 p.m. on a July afternoon in northern Utah. The ambient temperature was 82° F. The samples were left in place until steady-state was reached (as indicated by the thermocouple readings). The black section showed the highest temperature, the white section showed a substantially reduced temperature and the black/white section showed an intermediate temperature (see below). Even more significant results could likely be achieved through optimization of the coating process and material.

| Shingle Treatment | Steady State Temperature ° F. |
|---|---|
| Black | 139.2 |
| Black/White | 129.6 |
| White | 120.5 |

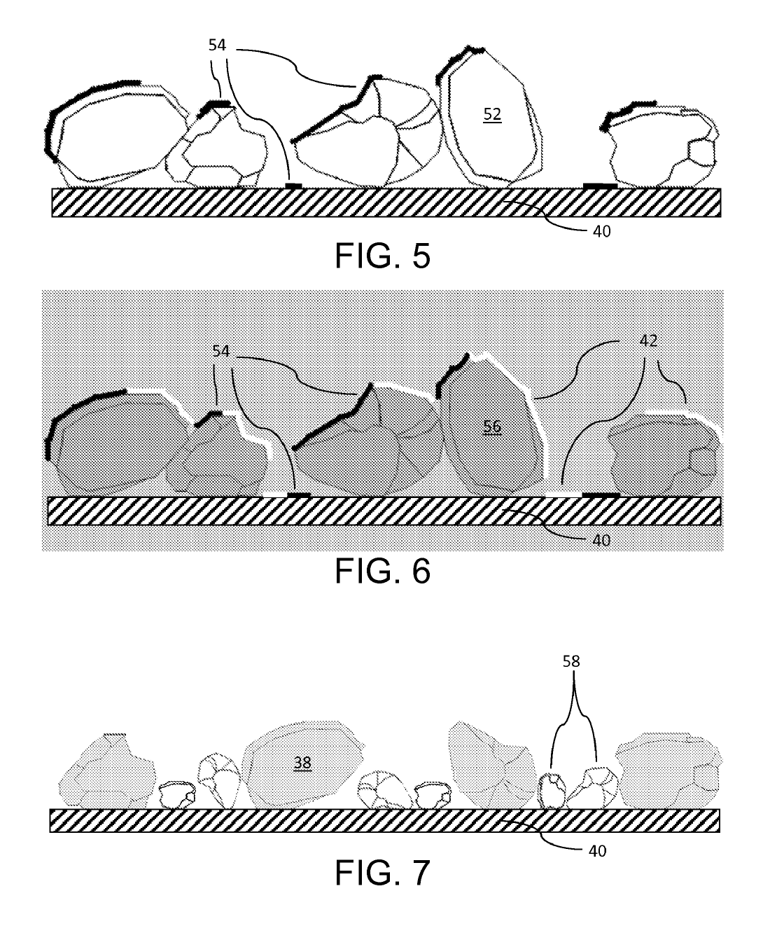

FIG. 5 depicts another embodiment wherein the rock granules 52 have high reflectivity prior to being adhered to an asphalt-impregnated substrate such as felt or fiberglass 40. In order to tailor the aesthetic properties, the irregular surface of the shingle is directionally treated with a coating 54 to enhance aesthetics on the surfaces of the shingle facing the view-direction. The surfaces facing the sun-direction are unchanged thereby maintaining their high reflectivity in that direction. This can easily be accomplished by applying the coating at a consistent predetermined angle with the proper application equipment and settings.

FIG. 6 depicts another embodiment wherein generic granules 56 are adhered to an asphalt-impregnated substrate such as felt or fiberglass 40. The granules are then modified with different coatings in the two directions. In order to tailor the aesthetic properties, the irregular surface of the shingle is directionally treated with a coating 54 to enhance aesthetics on the surfaces of the shingle facing the view-direction. The granules are also directionally coated with material with tailored radiation properties in the form of high reflectivity 42 on the surfaces of the shingles facing the sun-direction. This can easily be accomplished by applying the coatings at consistent predetermined angles with the proper application equipment and settings.

In some embodiments, the coating applied to the roofing material has a thermal reflectivity value of at least approximately 0.6. In some embodiments, the granules forming the non-planar surface of the roofing material have a thermal value of at least approximately 0.6.

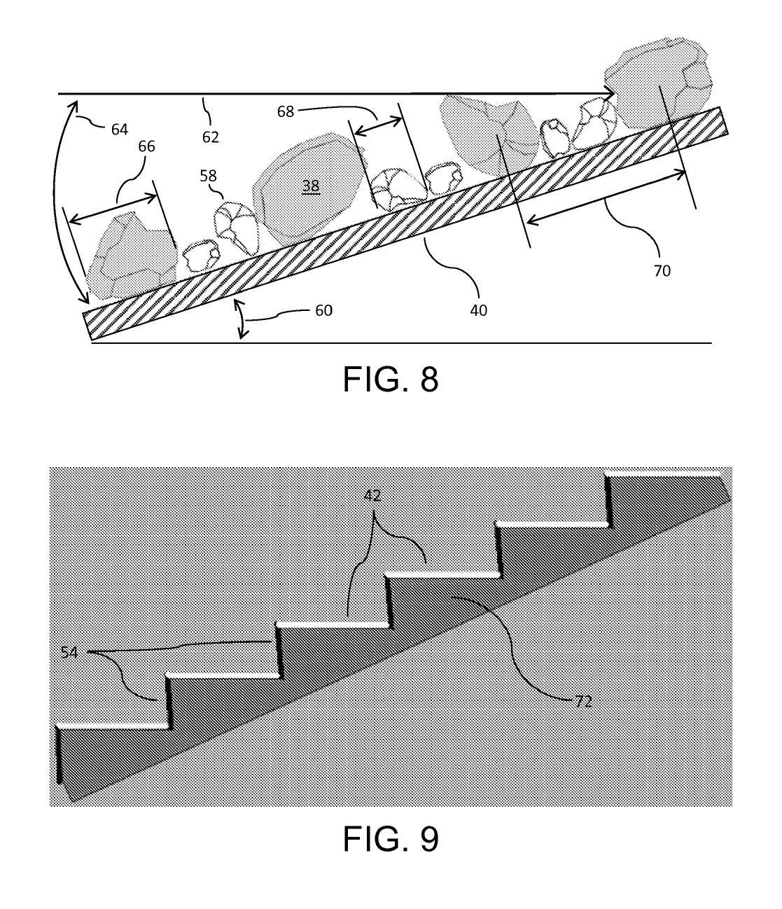

The directionally dependent conditions of enhanced reflectivity in the sun-direction and enhanced aesthetics in the view direction may also be achieved in another embodiment with a multi-modal size distribution of granules are adhered to an asphalt-impregnated substrate such as felt or fiberglass. A bimodal example of such an embodiment is illustrated in FIG. 7. Granules in the smaller size modes 58 are tailored to have highly reflective surfaces. Granules of larger modes have enhanced aesthetics 38. This results in improved reflectivity in the sun-direction since the smaller reflective particles are not blocked from views from above. The smaller reflective particles are somewhat obscured from view in the view-direction by the larger aesthetic particles, resulting in favorable aesthetics in that direction. Various size distributions and proportions can be used to achieve the desired effect. Patterning of the granules can range from random distribution to horizontal stripping with intermittent rows of large and small particles. The effectiveness of this embodiment would be determined by many factors shown in FIG. 8 including the roof angle 60, view direction 62, view angle 64, sizes of the granules 66 and 68, and the distance between the granules 70.

Roofing embodiments are not limited to the familiar asphalt shingle. Applications using shingles constructed of any composition such as slate, metal, fibrous cement, ceramics, wood, and concrete are possible by shaping and tailoring the surface properties for reflectivity in one direction and aesthetics in another. For example, a metal, plastic, or other type of roofing panel may be physically altered or treated to yield a surface texture that will take the treatment described below. In some embodiments, the panel may be crimped, stamped, embossed, etched, or otherwise altered to provide a patterned or random arrangement of raised and/or depressed portions that extend away from a primary surface of the panel. Other embodiments may use other types of roofing material. Such an embodiment is shown in FIG. 9 which illustrates a material of a stepped shape 72 with the faces of the steps facing in different directions tailored to have different properties. In this embodiment the steps facing in the sun-direction are directionally coated with a high reflectivity coating 42 in the sun-direction and have a directionally applied coating with tailored aesthetics 54 applied in the view-direction.

There is an on-going need for roofing materials that simultaneously provide enhanced aesthetics with enhanced thermal properties. Efforts to date have focused on balancing the desire for high reflectivity with that for darker tones, resulting in compromising both areas of interest. It appears that nothing short of tailoring properties of shingles at the granule level or with other irregularities in the surface such as angled steps to accomplish directional properties will be able to satisfy both needs simultaneously. This has not been accomplished by the prior art.

As described above, some of the embodiments provide a roofing material with both tailored radiation properties and tailored aesthetics. More importantly, these embodiments allow for a product with directionally specific tailoring of these two properties in order to reduce the inevitable compromise between the two. This provides a material that is marketable due to its tailored aesthetics and at the same time has a high reflectivity so that service temperatures are reduced. This results in increased effective service life and a reduction in cooling loads for the building. Furthermore, some embodiments of the shingles manufactured with directionally dependant properties have the following additional advantages:
it permits the production of directionally propertied shingles by the introduction of a simple coating process or two that lend themselves very well to current production techniques;
it permits the production of directionally propertied shingles by adding an additional granule size to current production techniques; and
it permits the production of directionally propertied shingles with a shape change in conjunction with the aforementioned adjustments.

In terms of visual appearance, some embodiments of roofing materials with directionally dependent properties are coated or otherwise finished to have varying finish properties. Similar to conventional shingles which may include a mixture of surface granules to achieve color variation in the look of installed shingles; multiple coatings may be directionally applied to achieve some variation in the color and/or performance properties of the roofing material. In some embodiments, the multiple coatings may be applied at substantially the same time as a mixture of different coatings. Alternatively, the multiple coatings may be applied one at a time, so that each coating material does not mix with other coating materials. The coating materials may be applied to generate a substantially random pattern. In another embodiment, the coating materials may be applied according to a specific coating process in order to achieve a substantially controlled pattern on the surface of the roofing material.

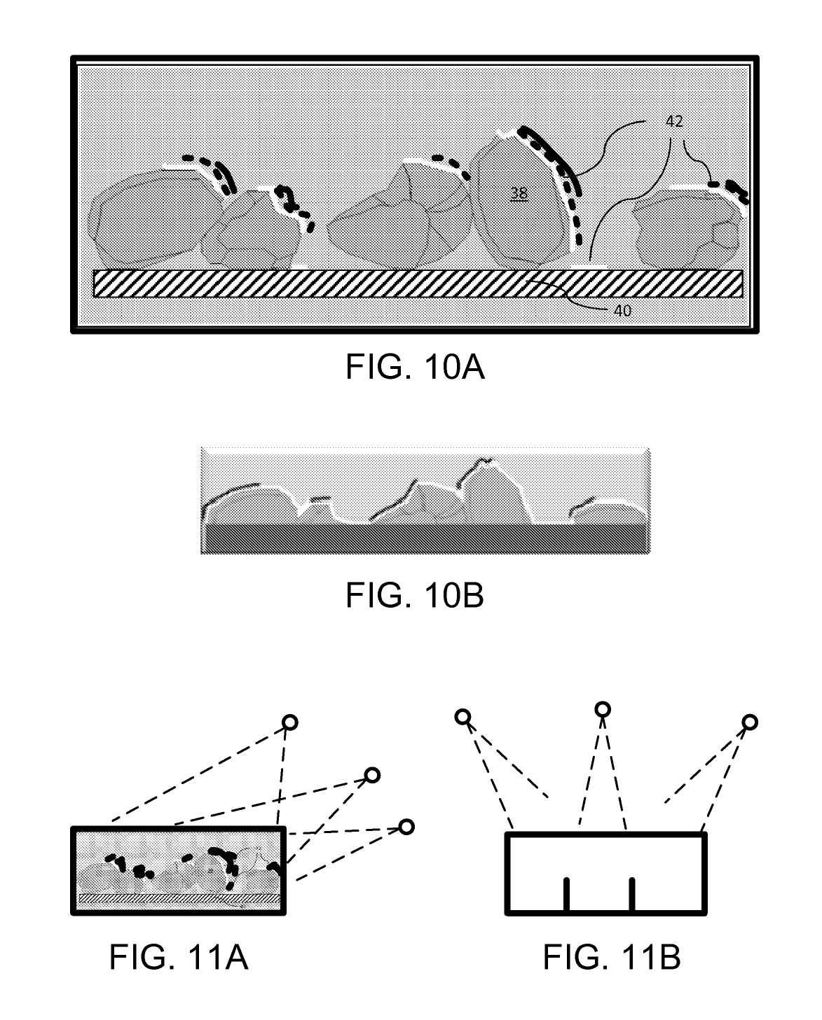

FIG. 10A depicts a schematic diagram of one embodiment of a controlled pattern of separate coatings 42 that may be achieved on granules 38 of an asphalt shingle 40 by sequentially applying the different coatings at different application angles. Some of the coatings may be applied specifically for visual appeal, while other coatings may be applied specifically for energy efficiency performance, while still other coatings may be applied to achieve some combination of visual appeal and energy efficiency.

In one embodiment, a first coating (shown as solid white lines) with first visual and/or performance properties is applied at a first incident angle relative to the normal of the roofing material. A second coating (shown as dashed black lines) with second visual and/or performance properties is applied at a second incident angle relative to the normal of the roofing material. In one embodiment, the second incident angle is greater than the first incident angle so that less of the granule surface is coated by the second coating, and at least some of the first coating remains exposed. In some embodiments, the second coating may have higher reflectivity characteristics, or other improved thermal or energy efficiency characteristics, relative to the first coating. In the illustrated embodiment, a third coating (shown as solid black lines) with third visual and/or performance properties is applied at a third incident angle relative to the normal of the roofing material. The third incident angle may be even greater than the second incident angle so that at least some of the second coating remains exposed, and the third coating may have even higher energy efficiency characteristics relative to the second coating. In this manner, or in other similar embodiments, the use of two or more coatings with different visual and/or performance properties can be applied in a controlled manner in order to achieve more precise patterns of coatings on the roofing material.

It should also be noted that the cross-sectional view provided in FIG. 10A only shows variation in the coating locations relative to one direction (e.g., up-down) of the shingle. In some embodiments, similar variations (random or patterned) also may be achieved in other directions (e.g., side-to-side or left-to-right).

FIG. 10B depicts a schematic diagram of another embodiment of a controlled pattern of separate coatings. In the illustrated embodiment, the base coating (shown in white) is applied to substantially the entire non-planar surface of the base material and the granules. In one embodiment, the base coating is applied in a substantially uniform manner to the non-planar surface. The top coating is then applied directionally, so that less than all of the surface of the granules is covered.

FIG. 11A depicts a cross-sectional view of one embodiment of various incident angles from which different coatings may be applied to a roofing material.

In one embodiment, the incident angles vary between about 75-85 degrees from the normal (about 5-15 degrees from the parallel of the underlying surface). In other embodiments, the incident angles may vary more or less (e.g., between about 60-90 degrees) from the normal.

FIG. 11B depicts a plan view of another embodiment of various incident angles from which different coatings may be applied to a roofing material. In some embodiments, different incident angles and/or coating patterns may be achieved by locating different nozzles or other coating emitters at different physical locations relative to the shingles. In other embodiments, different incident angles may be achieved in part by using nozzles or other coating emitters which have different emission patterns (e.g., wide angle, fan, etc.).

In some embodiments, the coating process uses a fine mist of paint or other coating falling gently like rain instead of at high velocity right out of a spray nozzle. An atomizer at the top of a tall booth may be implemented to emit droplets of coating material(s) that fall slowly onto the shingle at a particular angle or angles. In some embodiments, the angle of the shingle relative to the atomizer may be changed to allow different coatings to be applied at different angles. In another embodiment, different coatings are applied by different atomizers at different angles within the booth by slightly rotating or twisting the shingles as they pass under each of the atomizers. Other methods of application may also be used. For example, an electrical charge based system, a gravity coating system, a chemical deposition, or spin coating system may be used.

In some embodiments, the tones of different coatings are all very light and, therefore, quite reflective. This would go a long way in keeping the roof looking “normal” and would mask the color change due to perspective or roof viewing angle. As one example, this could be done with simple 3 tab shingles by varying the spray direction along the shingle (a very simple way to make 3-tab look more architectural) or with architectural grade much as they do now by mixing the pieces prior to bonding.

In further embodiments, the order in which coatings might be applied can be established so that coatings with higher energy efficiency properties are applied last and, hence, are substantially exposed to sunlight or other sources of energy. Similarly, the relative quantities of coatings may be set so that higher quantities of more efficient coatings are used.

In regard to other aspects of the shingle manufacturing process, in some embodiments, the way that the granules are applied to the asphalt-saturated felt base of the shingle may be varied in order to achieve different visual and/or energy efficiency performance properties. In some embodiments, the granules are pressed into the asphalt-saturated felt base at a decreased depth relative to conventional shingles. This may allow the granules to be exposed more at the end of the manufacturing process and, consequently, receive more directional coating than if the granules were pressed further into the asphalt-saturated felt base. In another embodiment, an additional heating stage may be added to the manufacturing process. After the granules are pressed into the asphalt-saturated felt base, the shingle is then exposed to a heating stage in order to raise the granules some distance out of the asphalt-saturated felt base. The raised granules then may be coated to a greater extent than if the granules were pressed further into the asphalt-saturated felt base.

In another embodiment, some or all of the granules may be directionally coated prior to being pressed into the base material. In this embodiment, an additional coating (or constituent of the color coating) may be used to decrease adhesion of the asphalt material of the base to the surface of the granule that is coated with a color or material that has a reflectivity that is different from the reflectivity of the asphalt. This anti-adhesion coating may be applied on top of a colored coating or in combination with a colored coating. In one embodiment, the anti-adhesion coating is mixed with the color coating prior to application of the color coating. In another embodiment, the anti-adhesion coating is applied at approximately the same time as the color coating, allowing the two coatings to mix while disposed on the granules. In another embodiment, the anti-adhesion coating may be applied on top of the color coating after the color coating has sufficiently dried or cured to substantially prevent mixing.

In further embodiments, tailored shapes and/or sizes (or mix of shape and/or sizes) of granules may be used. In other embodiments, multiple granule applications may be implemented so that some granules are added and pressed into the asphalt-saturated felt base during a first stage, and then other granules are added and pressed into the asphalt-saturated felt base at a different depth. Additionally, the granules of the different pressing stages could be different sizes, generally. For example, the second pressing stage may be implemented with larger granules so that the larger granules are more exposed after the second pressing stage. Any number of pressing stages may be implemented. In some embodiments, at least one of the pressing stages may be implemented with a rubber roller (or other material with a soft exterior or variable firmness) so that the larger granules create a threshold for how far smaller granules might be pressed into the asphalt-saturated felt base. In other embodiments, granules may be bonded differently (e.g., using better adhesives) to the asphalt-saturated felt base in order to eliminate the need for pressing. As one example, enhanced versions of asphalt that are more flexible and stronger than conventional asphalt may be used to bond granules to the asphalt-saturated felt base.

In further embodiments, granules are coated with an absorbing material that serve as a bonding agent to facilitate bonding the directional coating(s) to the granule and, in some embodiments, substantially prevent bleeding or flow of the coating onto unintended locations or sides of the granules. Some possible examples of bonding agents or absorbing materials include, but are not limited to, porous ceramic materials, clear or substantially transparent primers, and colored primers which match one or more of the colors of the coating material(s).

In further embodiments, the coatings may be produced with minimal or relatively low levels of surfactant(s) in order to minimize or substantially prevent back-side bleeding of the coating on the granules. In other embodiments, airless or other application techniques may be used to apply the coating(s) to the granules.

In some embodiments, coating the shingles before applying them to a roof eliminates the problem of sealing the interface between the shingles at the lower edge of each shingle that allows water to run out from under the shingle as designed (sometimes voiding shingle warranties). Instead of using conventional techniques to roll or spray coatings onto roofing surfaces in a manner that seals adjacent rows of shingles together, preventing air or fluid flow between the adjacent shingles, at least some of the embodiments described herein avoid inadvertently sealing adjacent rows of shingles together because the application angle prevents application of the coating(s) at the interface between the adjacent rows of shingles.

In further embodiments, methods may be implemented to apply directional coating(s) to existing roofing materials. In one embodiment, an applicator (e.g., sprayer nozzle) is mounted to a mounting device which maintains the applicator at an acceptable angle of incidence (or within an acceptable range) relative to the roofing material. In some embodiments, the applicator and/or mounting device use a running rail to guide the applicator and/or the mounting device along different rows of shingles. The running rail may be secured to a location on the roof such as a “hook” or other implement to mount the rail relative to the roof peak. Other devices may clamp to a particular row of shingles or other roofing equipment. In some embodiments, the applicator may be automated or semi-automated to travel at a particular speed. In further embodiments, multiple applicators, or a single applicator with multiple coating connections, may be used to apply a variety of coating materials at the same time, or at different times, and at the same or different incident angles. In some embodiments, a shield or other device may be used to cover up lower rows of shingles which otherwise might receive overspray. In one embodiment, the applicator may move horizontally across the roof. In another embodiment, the applicator may move vertically up and down the roof. In other embodiments, the applicator may follow other patterns for application to an existing roof.

In regard to testing, various testing approaches may be used. While many conventional testing approaches rely on testing with a heat or light source located at a normal angle relative to the surface of the shingle, some embodiments may implement testing at an angle relative to the surface of the shingle. In a specific example using ASTM Standard C1549, 2009, for directionally applied coating(s), an appropriately shaped spacer may be placed between test samples and the instrument to accomplish various angles while minimizing or substantially preventing unnecessary light leakage.

In certain embodiments, it may be useful to test roofing materials with directionally dependent properties using techniques which can readily be compared with conventional shingles that do not have directionally dependent properties. While such testing may have disadvantages, in some regards, the testing can be performed under the assumption that roofing materials with directionally dependent properties should perform at least as well as other conventional roofing materials when tested at the normal. And any improvement in performance at other angles corresponding to the direction of the sun will be better than the results acquired during testing. In some embodiments, angled spacers may be used to align test equipment with shingles to be tested. Some of the angled spacers may include reflective surfaces to allow reflected light to eventually be redirected to the test equipment.

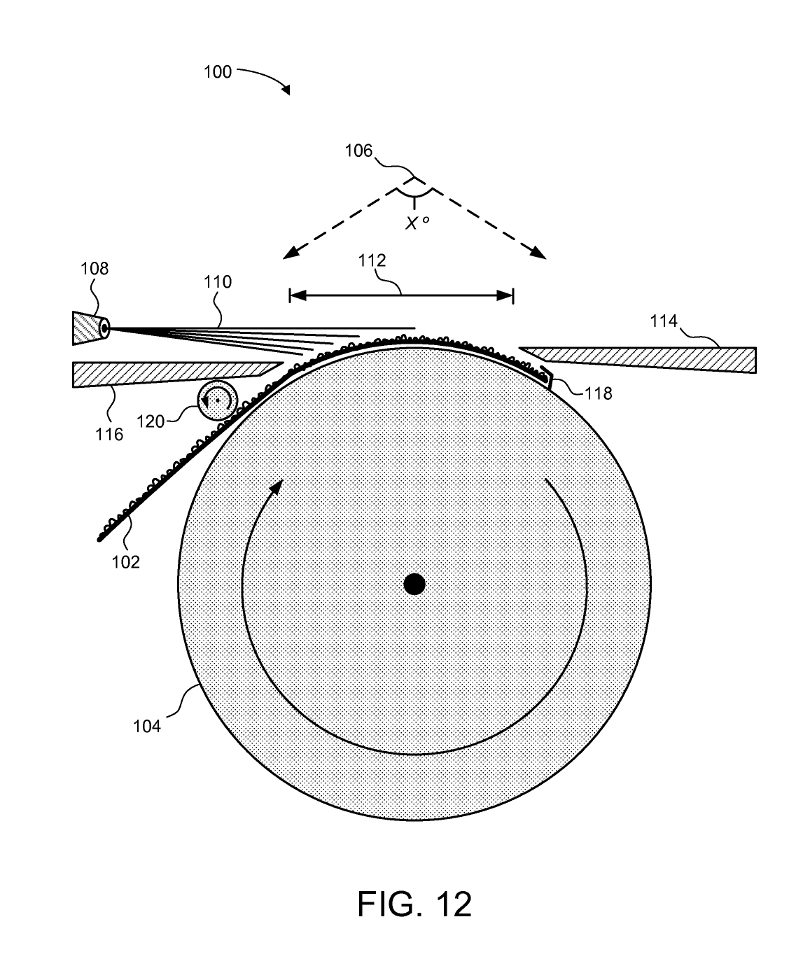

FIG. 12 depicts a schematic diagram of a system 100 for treating a roofing material 102 to have a coating of material of high reflectivity in the sun-direction and a dark material in the view-direction. In the illustrated embodiment, the roofing material 102 passes over a roller 104. The roofing material 102 is deformed as it moves over the roller 104. The roofing material may be bent at an angle 106 of various degrees. As the roofing material is deformed, a nozzle 108 creates a spray pattern 110 of surface treatment or coating material that adheres to the roofing material 102. The application area 112 for the system 100 is defined at least in part by an overspray guard 114 and an underspray or drip guard 116. The guards 114 and 116 prevent unwanted application of the coating material to the roofing material 102.

In some embodiments, the roofing material 102 is a felt, fiberglass, or mesh based shingle. Other embodiments may include metal, plastic, cloth, wood, or other type of roofing material that can be flexed without breaking or exhibiting purely plastic deformation after passing over the roller 104. In some embodiments, the roofing material 102 is a stepped material (see FIG. 9). In this embodiment, the roller 104 may have a patterned surface to improve the tracking of the roofing material 102 across the roller 104. In some embodiments, the roller 104 may be stationary with a smooth surface to allow the roofing material 102 to pass over the roller 104. In other embodiments, the roller 104 rotates to facilitate a controlled rate of movement of the roofing material 102 through the system 100. In some embodiments, the roller 104 may includes multiple channels or tracks to carry multiple feeds of roofing material 102 through the system 100 simultaneously.

In some embodiments, the roller 104 has a geometry to cause the roofing material 102 to bend at a slight angle 106. In other embodiments, the roller 104 is such that the roofing material is deformed heavily at a more dramatic angle 106.

Other embodiments may incorporate other degrees of angle 106 bends into the system 100 to achieve different textures, patterns, saturations, coverages, stiffnesses, geometries, surface features, or other qualities of the roofing material 102 or coating.

In some embodiments, the nozzle 108 pressure sprays the coating onto the roofing material 102. In other embodiments, the nozzle 108 applies a charge to the coating to electrically apply the coating to the roofing material 102. In this embodiment, a corresponding charge may be applied to the roofing material 102 to attract the coating.

In another embodiment, the illustrated system 100 is rotated ninety degrees so that the nozzle 108 is directed straight down and the coating is directed to the roofing material 102 by the force of gravity. Alternatively, the system 100 may be oriented to allow the nozzle 108 to spray straight up to apply the coating to the roofing material 102. In another embodiment, the roofing material 102 passes across the underside of the roller 104 and the nozzle 108 sprays the coating onto the roofing material. In this embodiment, the amount of overspray and inaccuracy of the application of the coating may be reduced because gravity will cause the excess coating to fall away from the roofing material 102.

In some embodiments, the nozzle 108 forms a spray pattern 110 of the coating. The nozzle 108 may be configured to spray at several angles, dispositions, or rates. The spray pattern 110 may be constant or may vary with time or location within the spray pattern 110 or location or angle relative to the roofing material 102. In some embodiments, the pressure behind the nozzle 108 may be varied or constant and controlled by a separate system (not shown). In some embodiments, the spray pattern 110 may sweep back and forth across the application area 112 or may be static and provide coverage to the entire breadth of the roofing material 102. The spray pattern 110 may have varied degrees of saturation depending on the location within the spray pattern 110. Other qualities of the spray pattern 110 may facilitate other patterns, coverage rates, coverage thicknesses, or other aspects of the coating or application process.

The illustrated embodiment also includes one or more flanges 118 to hold a leading edge of the roofing material 102 in place relative to the roller 104. The use of one or more flanges 118 may facilitate directing the leading edge of the roofing material 102 below the guard 114, which is described in more detail below. A single 118 flange may run substantially the length of the leading edge of the roofing material 102. Alternatively, multiple small, thin flanges 118 (e.g., wires, brackets, etc.) may be located across the width of the leading edge of the roofing material 102 so that the flanges 118 do not obstruct, or minimally obstruct, the application of the coating to the roofing material 102. Minimal obstruction refers to using a flange design that is no larger than is sufficient, within a reasonable design tolerance, to mechanically hold the leading of the roofing material 102 in place relative to the roller 104.

In order to feed the roofing material 102 through the system 100, one or more additional rollers 120 may be included. The roller 104 or any of the additional rollers 120 may be powered or passive. In some embodiments, at least one of the rollers 104, 120 is powered to advance the roofing material 102 through the system 100. In another embodiment, the rollers 104, 120 are all passive, and the roofing material 102 is advance through the system 100 under an external force from another feeding mechanism (not shown).

In some embodiments, the roofing material 102 is passed over multiple rollers 104 for application of multiple types of surface coatings. In some embodiments, the multiple coatings may mix during or after applications. In other embodiments, the individual coatings may be allowed to dry or cure prior to application of a subsequent coating. Other embodiments may include other application mechanics or schemes. In one embodiment, multiple coatings may be applied in such a manner as to vary the optical appearance of the coatings. For example, the coatings may be applied at several dispositions/angles or quantities. Other embodiments may incorporate other patterns or color schemes to improve the aesthetic and/or functional aspects of the roofing material 102 relative to the angle of viewing/impingement.

In the illustrated embodiment the application area 112 is the area of the roofing surface 102 that is exposed to the spray from the nozzle 108. In the illustrated embodiment, the application area 112 is at least partially defined by the guards 114 and 116. In some embodiments, the roofing material 102 is bent through the entirety of the application area 112. In other embodiments, the application area 112 also includes a relatively flat portion of the roofing material 102 before it contacts the roller 104 or after it breaks contact with the roller 104.

In some embodiments, the guards 114 and 116 are oriented to shield portions of the system 100 from the coating emitted from the nozzle 108. In some embodiments, the guards 114 and 116 prevent coating material from adhering to the roofing material 102 in an uncontrolled manner, such as overspray or dripping. In some embodiments, the guards 114 and 116 are coupled to a reclamation system (not shown) to recover coating material that did not adhere to the roofing material 102. In some embodiments, the guards 114 and 116 are simple panels or plates. Other embodiments of the guards may be screens, cloths, plastic sheets, or a directed air flow. For example, overspray guard 114 may be a strong directed flow of air that travels up the right side of the roofing material and carries overspray material away from the surface of the roofing material 102. Other embodiments of the guards 114 and 116 may include other means for preventing or reducing unwanted application of the coating to the roofing material 102.

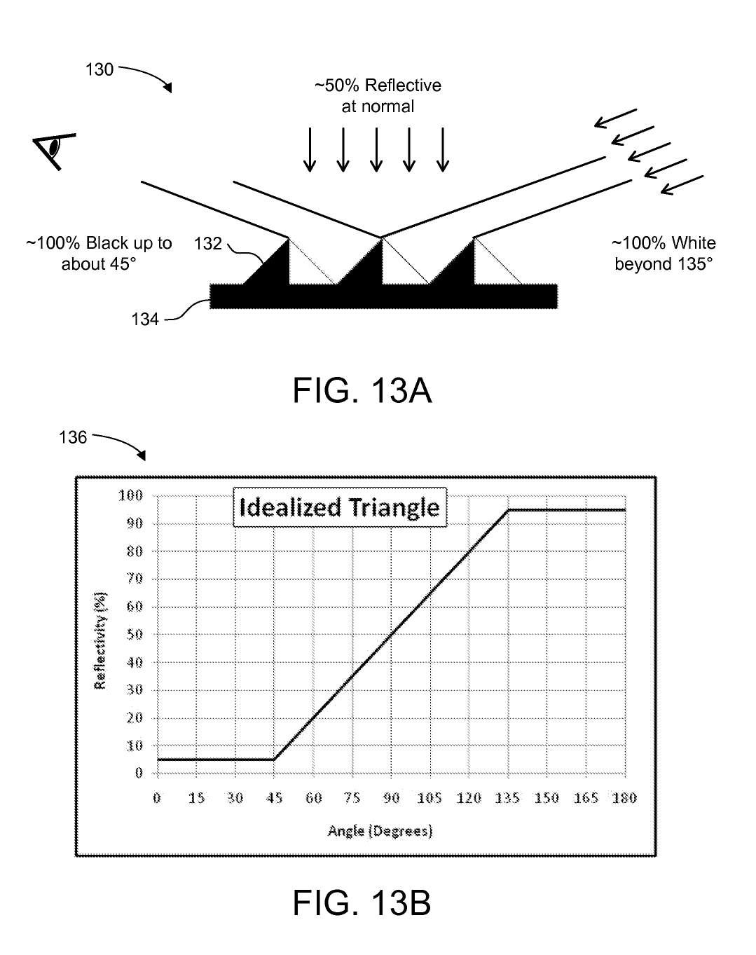

FIG. 13A depicts a cross-sectional view of one embodiment of a roofing material 130 with directionally toned triangular granules 132 applied to a base material 134. FIG. 13B depicts a graph 132 of a reflectivity response of the roofing material 130 of FIG. 13A. This graph 132 is based on a model in which the white side of the granules 132 is about 95% reflective and the dark side of the granules 132 is about 5% reflective. In other embodiments, stepped structures (e.g., stepped metal roofing) or embossed structures (e.g., embossed metal panels) may be implemented instead of surfaces with granules. This graph is also based on an assumption of perfect color separate without overspray during application of one or more coatings.

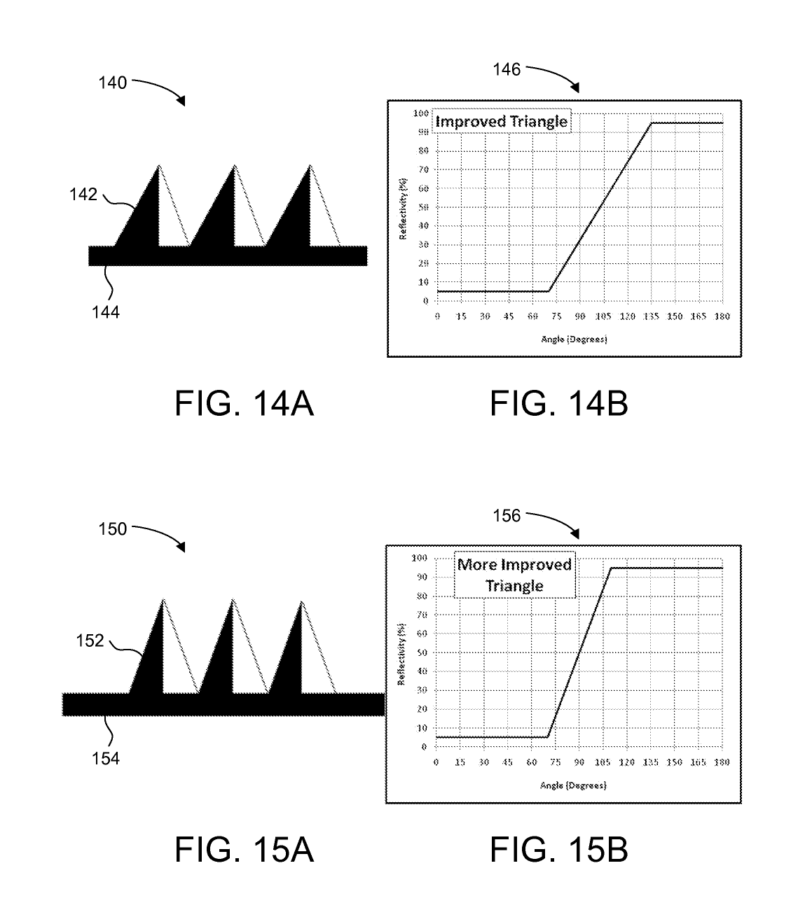

FIG. 14A depicts a cross-sectional view of another embodiment of a roofing material 140 with directionally toned triangular granules 142 with asymmetrical shapes. The granules 142 are applied to a base material 144. In this embodiment, the light side is at approximately 70 degrees, and the dark side is at approximately 135 degrees. Other embodiments may have other slopes. FIG. 14B depicts a graph 146 of a reflectivity response of the roofing material 140 of FIG. 14A.

FIG. 15A depicts a cross-sectional view of another embodiment of a roofing material 150 with directionally toned triangular granules 152 with asymmetrical shapes. The granules 152 are applied to a base material 154. In this embodiment, the light side is at approximately 70 degrees, and the dark side is at approximately 110 degrees. FIG. 15B depicts a graph 156 of a reflectivity response of the roofing material 150 of FIG. 15A.

By implementing some or all of the embodiments described herein, directional coatings may be applied to shingles or other roofing materials without significantly sacrificing the visual appearance of the shingle or other roofing materials. By applying one or more coatings at a variety of intensities, tones, and/or angles, such shingles or roofing materials may achieve improved energy efficiency and performance while retaining a resemblance to conventional shingles with varying tones and color schemes.

Although the description above contains much specificity, these should not be construed as limiting the scope of the embodiments but as merely providing illustrations of some of the presently envisioned embodiments. Thus the scope of the embodiments should be determined by the appended claims and their legal equivalents, rather than by the examples given.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A roofing material comprising:
a roofing material with at least one non-planar surface for exposure to environmental conditions;
a first coating directionally disposed on a portion of the non-planar surface to cover less than all of the non-planar surface, wherein the first coating has a visual attribute and an energy-efficiency attribute which are both different from corresponding visual and energy-efficiency attributes of the non-planar surface on which the first coating is disposed; and
a second coating directionally disposed on at least a portion of the first coating, wherein the second coating has a visual attribute which is different from the visual attributes of both the first coating and the non-planar surface.

2. The roofing material of claim 1, wherein the second coating has an energy-efficiency attribute which is different from a corresponding energy-efficiency attribute of the non-planar surface.

3. The roofing material of claim 2, wherein the first and second coatings are disposed to form a controlled pattern of multiple colors on the non-planar surface of the roofing material.

4. The roofing material of claim 1, wherein the second coating has an energy-efficiency attribute which is different from the energy-efficiency attribute of the first coating.

5. The roofing material of claim 1, wherein portions of the non-planar surface which are not coated by the first and second coatings are aligned to face substantially the same direction.

6. The roofing material of claim 1, wherein the base material comprises a granule-coated asphalt shingle.

7. The roofing material of claim 1, wherein the base material comprises a stepped roofing panel.

8. The roofing material of claim 1, wherein the base material comprises a metal roofing panel.

9. The roofing material of claim 1, wherein at least one of the first and second surface treatments has a thermal reflectivity value that is different from a thermal reflectivity value of the non-planar surface of the roofing shingle.

10. The roofing material of claim 9, wherein the thermal reflectivity value of at least one of the first and second surface treatments is greater than the thermal reflectivity value of the surface of the base material.

11. A method of manufacturing a roofing material, the method comprising:
positioning a roofing material relative to a coating nozzle for first and second coatings;
directionally applying the first coating on a portion of the non-planar surface to cover less than all of the non-planar surface, wherein the first coating has a visual attribute and an energy-efficiency attribute which are both different from corresponding visual and energy-efficiency attributes of the non-planar surface on which the first coating is disposed; and
directionally applying the second coating on at least a portion of the first coating, wherein the second coating has a visual attribute which is different from the visual attributes of both the first coating and the non-planar surface.

12. The method of claim 11, wherein applying the first and second coatings further comprises applying the second coating at after applying the first coating.

13. The method of claim 11, wherein applying the first and second coatings further comprises applying the second coating concurrent with the first coating.

14. The method of claim 13, wherein applying the first and second coatings concurrently facilitates at least partially mixing the first and second coatings.

15. The method of claim 11, wherein positioning the roofing material further comprises bending the roofing material and positioning a bent portion of the roofing material within a spray path of the coating nozzle.

16. The method of claim 15, wherein bending the roofing material comprises applying force from a roller to the roofing material.

17. The method of claim 15, wherein bending the roofing material comprises deflecting the roofing material within an elastic deformation region of the roofing material.

18. The method of claim 15, wherein bending the roofing material comprises deflecting the roofing material at least partially into a plastic deformation region of the roofing material to form a structural shape characteristic of the roofing material.

19. The method of claim 11, further comprising shielding the base material along the path with at least one guard during the application of at least one of the first and second coatings to substantially prevent deposition of overspray onto the roofing material.

20. The method of claim 19, wherein the guard facilitates at least partial reclamation of at least one of the first and second coatings.
